(19) United States
(12) Patent Application Publication
(10) Pub. No.: US 2021/0383688 A1
(43) Pub. Date: Dec. 9, 2021

(54) TRAFFIC MONITORING AND EVIDENCE COLLECTION SYSTEM

(71) Applicant: Senken Group Co., Ltd., Wenzhou, Zhejiang (CN)

(72) Inventors: Xu CHEN, Wenzhou, Zhejiang (CN); Chaoqun ZHU, Wenzhou, Zhejiang (CN); Chengyang RUAN, Wenzhou, Zhejiang (CN)

(21) Appl. No.: 17/280,673

(22) PCT Filed: Sep. 27, 2019
(86) PCT No.: PCT/CN2019/108544

§ 371 Date: Mar. 26, 2021

(30) Foreign Application Priority Data
Sep. 28, 2018 (CN) PCT/CN2018/108463

(51) Int. Cl. G08G 1/017; G08G 1/054; G06K 9/00; G06K 9/46; H04N 5/225; H04N 5/232; H04N 5/58; G01S 13/72; G01S 13/86

(52) U.S. Cl. CPC G08G 1/0175; G08G 1/054; G06K 9/00825; G06K 9/00771; G06K 9/00288; G06K 9/4661; G06K 2209/23; H04N 5/23238; H04N 5/58; G01S 13/726; G01S 13/867; G06K 2209/21; H04N 5/2252

(57) ABSTRACT

A system and method for traffic monitoring and evidence collection. The system can include a housing(130,330,630,730) configured to be mounted on top of a vehicle; a police light(112a,112b,312a,312b); a terminal(420) located outside the housing(130,330,630,730)and configured to send a control signal; and one or more image capturing cameras(318a˜318e,618a˜618g,718a˜718h) configured to capture an image in response to the control signal from the terminal(420), wherein the one or more image capturing cameras(318a˜318e,618a˜618g,718a˜718h,) are located within the housing(130,330,630,730).

### CROSS REFERENCE TO RELATED APPLICATIONS

This application claims priority to PCT Application No.: PCT/CN2018/108463, entitled “TRAFFIC MONITORING AND EVIDENCE COLLECTION SYSTEM,” and filed Sep. 28, 2018, which is incorporated herein in its entirety.

### BACKGROUND

Traffic violations can be a major cause of traffic accidents, having severe impact on the safety of vehicle drivers and passengers. Improved monitoring and evidence collection of traffic violations on the road can lead to better prevention of traffic accidents. And public interest, health, lives, and economic prosperity, can be better protected in an improved driving condition. Police departments in most countries are charged with the responsibilities of monitoring traffic conditions, preventing and stopping traffic violations, however, their daily job on the road can face various challenges. To overcome the challenges of collecting evidence for various traffic violations, for example in real time, a fast and intelligent system for traffic monitoring and evidence collection can be highly desirable.

### SUMMARY

Disclosed herein is a system, comprising: a housing configured to be mounted on top of a vehicle; a police light; a terminal located outside the housing and configured to send a control signal; and one or more image capturing cameras configured to capture image in response to the control signal from the terminal, wherein the one or more image capturing cameras are located within the housing.

In some cases, the system comprises two image capturing cameras positioned on a front side of the housing, and wherein optical axes of the two image capturing cameras intersect at back of the two front-facing cameras. In some cases, the two image capturing cameras are configured to have a combined field of view that is at least 120 degree, at least 150 degree, or 180 degree. In some cases, the speed detector is positioned between the two image capturing cameras. In some cases, the one or more image capturing cameras are affixed to the housing. In some cases, the one or more image capturing cameras have an image resolution that is at least 1 megapixel, at least 5 megapixel, at least 10 megapixel, at least 50 megapixel, or at least 100 megapixel. In some cases, the one or more image capturing cameras have a frame rate of at least about 100 fps (frames per second), at least about 250 fps, at least about 500 fps, or at least about 1000 fps. In some cases, the one or more image capturing cameras are configured to capture moving images with exposures of less than about 2 ms, less than about 1 ms, less than about 0.8 ms, less than about 0.6 ms, less than about 0.5 ms, less than about 0.4 ms, less than about 0.2 ms, or less than about 0.1 ms.

In some cases, the system further comprises a processing unit configured to detect a traffic violation based on analysis of surveillance image obtained by the at least one of the image capturing cameras.

In some cases, the processing unit is configured to trigger the image capturing camera to capture an image of the detected traffic violation. In some cases, the processing unit is configured to detect a traffic violation selected from the group consisting of: driving in a reverse direction, failing to drive within a single lane, crossing over a center divider, median or gore, driving in an unauthorized lane, driving on a shoulder, parking violation, and any combinations thereof. In some cases, the speed detector is a multi-target tracking radar configured to track and detect speed of multiple objects.

In some cases, the system further comprises one or more panoramic cameras. In some cases, the system comprises four panoramic cameras positioned at four corners of the housing. In some cases, the system comprises two panoramic cameras positioned at a left side and a right side of the housing, respectively. In some cases, the system further comprises a plurality of illumination lights configured to provide illumination for image capture, wherein the illumination lights are attached to the housing. In some cases, the system further comprises a light sensor, and wherein the system is configured to detect ambient lighting condition through the light sensor and adjust the illumination from the illumination lights based on the detected ambient lighting condition.

In some cases, the system further comprises a satellite-based radionavigation receiver configured to obtaining positioning information of the system. In some cases, the system is configured to obtain and record positioning information of a traffic violation. In some cases, the police light is positioned above the one or more image capturing cameras. In some cases, the system further comprises a speaker attached to the housing. In some cases, the speaker is placed within the housing. In some cases, the system further comprises LED display panel attached to the housing. In some cases, the LED display is at back side of the housing. In some cases, the system further comprises a wireless communication module configured to communicate with a remote server. In some cases, the wireless communication module communicates with the remote server through 3G/4G wireless network, WiFi, or Bluebooth. In some cases, the terminal is configured to provide a graphical user interface for an operator of the system. In some cases, the terminal comprises a touch-screen monitor configured to receive input from the operator.

In some cases, the system further comprises a computer configured to: (1) process and analyze image captured by the one or more image capturing cameras or speed detection data obtained by the speed detector; (2) control the one or more image capturing cameras based on analysis of the image or an input received by the terminal; and/or (3) control the terminal to display monitoring data obtained by the one or more image capturing cameras or the speed detector. In some cases, the computer is positioned within the housing. In some cases, the computer is positioned outside the housing. In some cases, the computer is configured to analyze facial image captured by the one or more image capturing cameras. In some cases, the computer is further configured to identify a person from the facial image captured by the one or more image capturing cameras.

In another aspect, disclosed herein is a method of adjusting a camera, comprising: a) sending a control signal from a terminal of a system to one or more image capturing cameras, wherein the system comprises: a housing configured to be mounted on top on a vehicle; a police light; the terminal located outside the housing; and the one or more image capturing cameras, wherein the one or more image capturing cameras are located within the housing; and b) adjusting the one or more image capturing cameras in response to the control signal from the terminal.

In some cases, the adjusting comprises setting the one or more image capturing cameras in one or more of the following modes: (i) snapshot mode, in which the one or more image capturing cameras are configured to capture snapshot images; (ii) speed detection mode, in which the one or more image capturing cameras are configured to capture images of a speeding vehicle detected by the speed detector; and (iii) surveillance mode, in which the one or more image capturing cameras are configured to capture video stream. In some cases, the adjusting comprises adjusting one or more configurations of the one or more image capturing cameras selected from the group consisting of: focal plane, orientation, positioning relative to the housing, exposure time, and frame rate. In some cases, the method further comprises: sending a monitoring commend from the terminal to: control the speed detector to detect the object; control the police light; control illumination lights of the system to provide illumination for the image capturing; control alarm speaker of the system; control one or more panoramic cameras of the system to conduct surveillance; or control a satellite-based radionavigation receiver of the system to obtain positioning information of the system.

In some cases, the system comprises two image capturing cameras positioned on a front side of the housing, and wherein optical axes of the two image capturing cameras intersect at back of the two front-facing cameras. In some cases, the two image capturing cameras are configured to have a combined field of view that is at least 120 degree, at least 150 degree, or 180 degree. In some cases, the speed detector is positioned between the two image capturing cameras. In some cases, the one or more image capturing cameras are affixed to the housing. In some cases, the one or more image capturing cameras have an image resolution that is at least 1 megapixel, at least 5 megapixel, at least 10 megapixel, at least 50 megapixel, or at least 100 megapixel. In some cases, the one or more image capturing cameras have a frame rate of at least about 100 fps (frames per second), at least about 250 fps, at least about 500 fps, or at least about 1000 fps. In some cases, the one or more image capturing cameras are configured to capture moving images with exposures of less than about 2 ms, less than about 1 ms, less than about 0.8 ms, less than about 0.6 ms, less than about 0.5 ms, less than about 0.4 ms, less than about 0.2 ms, or less than about 0.1 ms.

In some cases, the image capturing camera comprises a processing unit configured to detect a traffic violation based on analysis of surveillance images obtained by the at least one of the image capturing cameras. In some cases, the processing unit is configured to trigger the image capturing camera to capture an image of the detected traffic violation. In some cases, the processing unit is configured to detect a traffic violation selected from the group consisting of: driving in a reverse direction, failing to drive within a single lane, crossing over a center divider, median or gore, driving in an unauthorized lane, driving on a shoulder, parking violation, and any combinations thereof. In some cases, the speed detector is a multi-target tracking radar configured to track and detect speed of multiple objects.

In some cases, the system further comprises one or more panoramic cameras. In some cases, the system comprises four panoramic cameras positioned at four corners of the housing. In some cases, the system comprises two panoramic cameras positioned at a left side and a right side of the housing, respectively. In some cases, the system further comprises a plurality of illumination lights configured to provide illumination for image capture, wherein the illumination lights are attached to the housing. In some cases, the system further comprises a light sensor, and wherein the system is configured to detect ambient lighting condition through the light sensor and adjust the illumination from the illumination lights based on the detected ambient lighting condition. In some cases, the system further comprises a satellite-based radionavigation receiver configured to obtaining positioning information of the system. In some cases, the system is configured to obtain and record positioning information of a traffic violation. In some cases, the police light is positioned above the one or more image capturing cameras. In some cases, the system further comprises a speaker attached to the housing. In some cases, the speaker is placed within the housing. In some cases, the system further comprises LED display panel attached to the housing. In some cases, the LED display is at back side of the housing.

In some cases, the method further comprises a wireless communication module configured to communicate with a remote server. In some cases, the wireless communication module communicates with the remote server through 3G/4G wireless network, WiFi, or Bluebooth. In some cases, the terminal is configured to provide a graphical user interface for an operator of the system. In some cases, the terminal comprises a touch-screen monitor configured to receive input from the operator. In some cases, the terminal further comprises a computer configured to: (1) process and analyze image captured by the one or more image capturing cameras or speed detection data obtained by the speed detector; (2) control the one or more image capturing cameras based on analysis of the image or an input received by the terminal; or (3) control the terminal to display monitoring data obtained by the one or more image capturing cameras or the speed detector. In some cases, the computer is positioned within the housing. In some cases, the computer is positioned outside the housing. In some cases, the computer is configured to analyze facial image captured by the one or more image capturing cameras. In some cases, the computer is further configured to identify a person from the facial image captured by the one or more image capturing cameras.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a picture of an exemplary device.

FIGS. 2A and 2B show pictures of a front view and a rear view of another exemplary device, respectively.

FIGS. 3A and 3B shows a front view and a rear view, respectively, of yet another exemplary external device.

FIG. 4 is a schematic of a system for traffic monitoring and evidence collection.

FIG. 5 is a flowchart illustrating a method of traffic monitoring and evidence collection.

FIG. 6 is a cross sectional view of an exemplary device.

FIGS. 7A-7C show a cross sectional view, a front view, and a side view, respectively, of another exemplary external device.

### DETAILED DESCRIPTION

One aspect of the present disclosure relates to apparatus, systems, and methods for traffic monitoring and evidence collection. In some embodiments, the apparatus, systems, and methods as provided herein provides an integrated solution for traffic monitoring and evidence collection. An operator of a system as provided herein can perform a number of different traffic monitoring and evidence collection tasks efficiently. Apparatus, systems, and methods as provided herein can be applicable in detecting and collecting evidence on a series of different traffic violations.

A system as provided herein can comprise a housing configured to be mounted on top of a vehicle, a police light, a speed detector configured to detect a speed of an object, a terminal located outside the housing and configured to receive and/or send a control signal, and one or more image capturing cameras configured to capture an image in response to the control signal from the terminal. In some embodiments, the speed detector and the one or more image capturing cameras are located within the housing of the system. The system as provided herein can provide an intelligent and integrated interface for video surveillance, image capture, and/or speed detection.

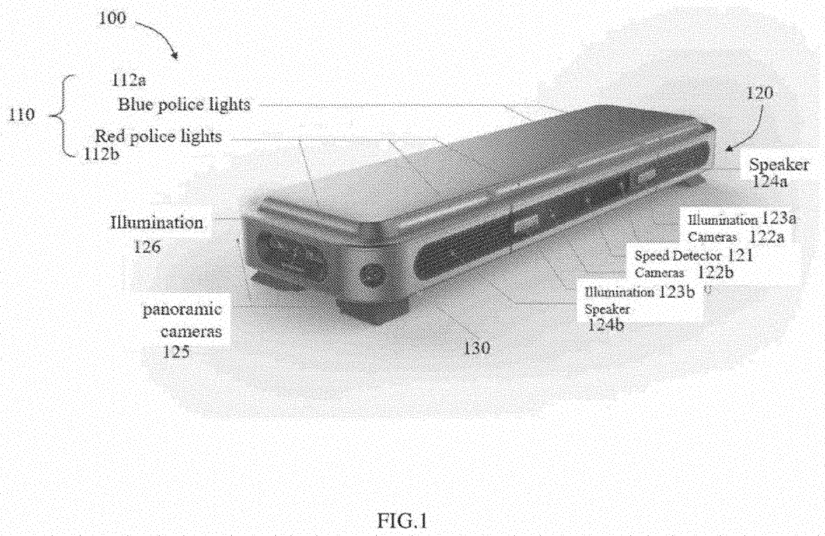

A housing of the system as described herein can be one continuous enclosure. In some embodiments, the system is highly integrated. Most, if not all, components, except the terminal can be contained within the housing, which altogether can form an external device (see, e.g., FIG. 1 to FIG. 3B). The external device can be the part of the system mounted on top of the exterior of a vehicle. The external device can be mounted on any appropriate exterior part of a vehicle, such as the top of a vehicle, windshield, back windows, side windows, and any other part that can provide space for image capturing cameras to capture images of the surrounding of the vehicle. In some cases, the external device is not necessarily mounted on the exterior of a vehicle, for instance, it can be mounted on the interior side of the windshield or any other windows of the vehicle. A system as provided herein can be highly integrated and save space on the vehicle. A system as provided herein can save time for installation or mounting onto the vehicle. In some cases, the housing has one continuous compartment. In other cases, the housing comprises more than one compartment, each of which is completely or partially separated from other compartments. A housing as provided herein can be configured to be mounted on top of a vehicle. In some cases, the housing comprises hook, belt, loop, clamp, or other mechanism for mounting onto a vehicle. In some cases, the housing is configured to be engageable to other attachment mechanism that can mount the external device onto a vehicle. For instance, the housing may not comprise any special attachment mechanism, while the housing can be attached onto a vehicle by a belt, hook, clamp, loop, or other attachment mechanism. In some embodiments, the housing and the vehicle (or a portion of the vehicle) can be coupled together via a mechanical method (e.g., using a belt, loop, clamp, or hook). In some embodiments, the housing and the vehicle (or a portion of the vehicle) can be coupled together via a magnetic method (e.g., using permanent or electromagnetic magnets).

A housing can be made of any appropriate material, such as any appropriate plastics, resin, or metal. In some cases, a housing is made of iron, brass, copper, platinum, palladium, rhodium, titanium, steel, aluminum, nickel, iron, zinc, or any combination or alloy thereof. A housing can be of any appropriate shape. In some cases, a housing is rectangular on the horizontal plane. In other cases, a housing is round, triangular, or of an irregular shape. A housing, for instance, a rectangular housing, can have a front side, a left side, a right side, and a back side, and four corners joint by any two of these four sides.

An image capturing camera as provided herein can be a digital camera that is configured to capture images of an object. In some examples, the system comprises one image capturing camera. In other examples, the systems comprises two or more, such as 2, 3, 4, 5, 6, 7, 8, 9, 10, or more image capturing cameras. The one or more image capturing cameras of the system can have a high image resolution, such as at least 1 megapixel, at least 2 megapixel, at least 3 megapixel, at least 4 megapixel, at least 5 megapixel, at least 10 megapixel, at least 20 megapixel, at least 50 megapixel, at least 100 megapixel, or higher. The one or more image capturing cameras can have an image resolution that is about 1 megapixel, about 2 megapixel, about 3 megapixel, about 4 megapixel, about 5 megapixel, about 10 megapixel, about 20 megapixel, about 50 megapixel, or about 100 megapixel. The one or more image capturing cameras can be high speed cameras. For example, in some cases, the one or more image capturing cameras have a frame rate that is at least about 100 fps (frames per second), at least about 200 fps, at least about 250 fps, at least about 300 fps, at least about 400 fps, at least about 500 fps, at least about 600 fps, at least about 700 fps, at least about 800 fps, at least about 900 fps, at least about 1000 fps, or at least about 2000 fps. In some cases, the one or more image capturing cameras have a frame rate that is about 100 fps, about 200 fps, about 250 fps, about 300 fps, about 400 fps, about 500 fps, about 600 fps, about 700 fps, about 800 fps, about 900 fps, about 1000 fps, or about 2000 fps. The one or more image capturing cameras can be configured to capture moving images with exposures of less than about 10 ms, less than about 5 ms, less than about 4 ms, less than about 3 ms, less than about 2 ms, less than about 1.5 ms, less than about 1 ms, less than about 0.9 ms, less than about 0.8 ms, less than about 0.7 ms, less than about 0.6 ms, less than about 0.5 ms, less than about 0.4 ms, less than about 0.3 ms, less than about 0.2 ms, or less than about 0.1 ms. The one or more image capturing cameras can be configured to capture moving images with exposures of about 10 ms, about 5 ms, about 4 ms, about 3 ms, about 2 ms, about 1.5 ms, about 1 ms, about 0.9 ms, about 0.8 ms, about 0.7 ms, about 0.6 ms, about 0.5 ms, about 0.4 ms, about 0.3 ms, about 0.2 ms, or about 0.1 ms.

In some embodiments, the one or more image capturing cameras are configured to capture high quality images of moving object when the object is moving at a speed of at least about 15 km/h, at least about 20 km/h, at least about 25 km/h, at least about 30 km/h, at least about 35 km/h, at least about 40 km/h, at least about 45 km/h, at least about 50 km/h, at least about 55 km/h, at least about 60 km/h, at least about 65 km/h, or at least about 70 km/h, at least about 75 km/h, at least about 80 km/h, at least about 90 km/h, or at least about 100 km/h. The one or more image capturing cameras are configured to capture high quality images of moving object when the object is moving at a speed of about 15 km/h, about 20 km/h, about 25 km/h, about 30 km/h, about 35 km/h, about 40 km/h, about 45 km/h, about 50 km/h, about 55 km/h, about 60 km/h, about 65 km/h, or about 70 km/h, about 75 km/h, about 80 km/h, about 90 km/h, or about 100 km/h. The speed as described herein can refer to a speed of the object relative to the image capturing cameras. One example is that the one or more image capturing cameras can be configured to take high quality images of a parking violation while the police vehicle is moving at a speed of, for instance, at least 30 km/h. Another example is that the one or more image capturing cameras can be configured to take high quality images of a speeding vehicle while the relative speed of the speeding vehicle exceeds, for instance, 80 km/h.

In some embodiments, the one or more image capturing cameras are configured to capture images of a target vehicle (or other moving object) when the absolute speed of the target vehicle (i.e., speed relative to the ground) is above a threshold. In these embodiments, the speed detector in the system can be configured to measure the relative speed and direction between the vehicle carrying the image capturing cameras. A processing unit (e.g., located within a terminal, see more details below) can acquire speed information about the vehicle carrying the image capturing cameras (e.g., from a GPS unit or speedometer) and then calculate the absolute speed of the target vehicle.

In some cases, the system comprises two image capturing cameras. The two image capturing cameras can be positioned on a left and a right portion of the front side of the housing, respectively. The positioning of the two image capturing cameras can be configured such that the two image capturing cameras can have a wide coverage of the field in front of the image capturing cameras. For instance, a combined field of view of the two image capturing cameras can be at least 120 degree, at least 130 degree, at least 140 degree, at least 150 degree, at least 160 degree, at least 170 degree, or 180 degree. A combined field of view of the two image capturing cameras can be about 120 degree, about 130 degree, about 140 degree, about 150 degree, about 160 degree, about 170 degree, or about 180 degree. In some cases, the two image capturing cameras are positioned such that the optic axes of the two image capturing cameras intersect at the back of the two image capturing cameras. In such positioning, an image capturing camera on the left portion of the front side of the external device can be oriented to shoot the left front side, and an image capturing camera on the right portion of the front side of the external device can be orientated to shoot the right front side. The image capturing cameras as provided herein can be affixed to the housing or can be mounted on a movable arm within the housing. Fixated image capturing cameras can be positioned as described herein, such that a wide-angle coverage can be achieved. Wide-angle coverage and high image resolution provided by image capturing cameras as described herein can also provide high speed and high quality solution for evidence collection, as compared to some conventional image capture solutions. For example, there can be no need to move the cameras in order to focus and capture a traffic violation. In some examples, fixated image capturing cameras can also avoid mechanical failures, heat, and/or high energy demand associated with movable cameras.

In some examples, the one or more image capturing cameras comprises a processing unit for detection of a traffic violation based on image analysis. In some examples, the processing unit can be disposed outside the image capturing cameras (e.g., within a terminal described below). The processing unit can include any suitable processing device configured to run or execute a set of instructions or code (e.g., stored in the memory) such as a general-purpose processor (GPP), a field programmable gate array (FPGA), a central processing unit (CPU), an accelerated processing unit (APU), a graphics processor unit (GPU), an Application Specific Integrated Circuit (ASIC), and/or the like. Such a processor can run or execute a set of instructions or code stored in the memory associated with using a PC application, a mobile application, an internet web browser, a cellular and/or wireless communication (via a network), and/or the like.

In some examples, the image capturing camera can be used for video surveillance besides image capture. The processing unit can receive and analyze the obtained video stream while the image capturing camera is working in the video surveillance mode. The processing unit can comprise hardware and software to implement methods for image analysis and pattern recognition. For example, the processing unit can be configured to perform image analysis and pattern recognition via machine learning techniques, including convolutional neural network (CNN). In another example, the processing unit can be configured to combine both machine learning techniques and classical methods for image analysis and pattern recognition.

In some instances, the processing unit can implement methods for recognition of traffic violations, such as, but not limited to, driving in a reverse direction, failing to stay within a driving lane, crossing over a center divider, median or gore, driving in an unauthorized lane (e.g., high-occupancy vehicle lane, carpool lane, lanes restricted to fuel efficient cars, buses, or vehicles transporting hazardous materials, emergency lanes), driving on a shoulder, parking violation, and any combinations thereof. In these instances, the processing unit can also be configured to perform lane recognition. In some implementations, the processing unit can be configured to perform lane recognition via image analysis and patter recognition (e.g., artificial neural network). In some implementations, the processing unit can be configured to perform lane recognition based, at least in part, on the location of the vehicle carrying the image capturing camera. For example, the processing unit can determine that the vehicle carrying the image capturing cameras is on a carpool lane based on the geolocation of the vehicle and any other vehicle on the same lane is also on the carpool lane (and therefore must comply with the regulations of carpool lanes).

In some embodiments, the geolocation information of the vehicle carrying the image capturing cameras can also be used to enforce any local regulations. For example, an area designated as a school zone can have more strict regulations on parking and drive speed. The processing unit can be configured to determine that the image capturing cameras enter the school zone based on their geolocation and therefor start detecting violations of the school zone regulations. In some instances, the processing unit can be configured to determine that a target vehicle is within a certain region (e.g., school zone) based on the location of the image capturing cameras and the distance between the image capturing camera and the target vehicle. The distance between the image capturing cameras and the target vehicle can be acquired via, for example, a rangefinder.

In some cases, the processing unit can further comprise hardware and software configured to trigger image capture by the image capturing camera upon detection of a traffic violation. For instance, an image capturing camera can work in a video surveillance mode, and the video stream obtained by the image capturing camera can be analyzed by a processing unit within the image capturing camera. Upon detection of a traffic violation, e.g., a vehicle driving in a reverse direction in a lane next to the police car bearing the system provided herein, the processing unit can send a control signal that directs the image capturing camera to capture an image of the traffic violation.

In some examples, there is a time interval between the detection of the traffic violation and the image capture. The time interval can be at most 5 sec, at most 4 sec, at most 3 sec, at most 2 sec, at most 1 sec, at most 0.9 sec, at most 0.8 sec, at most 0.7 sec, at most 0.6 sec, at most 0.5 sec, at most 0.4 sec, at most 0.3 sec, at most 0.2 sec, at most 100 msec, or at most 50 msec. The time interval can be about 5 sec, about 4 sec, about 3 sec, about 2 sec, about 1 sec, about 0.9 sec, about 0.8 sec, about 0.7 sec, about 0.6 sec, about 0.5 sec, about 0.4 sec, about 0.3 sec, about 0.2 sec, about 100 msec, or about 50 msec.

In some examples, the system further comprises one or more panoramic cameras (including cameras with wide angle lenses or fisheye lenses). In some embodiments, the one or more panoramic cameras are attached to the housing, for example, contained within the housing, or attached to the exterior of the housing. The one or more panoramic cameras can be configured for video surveillance purpose. In some cases, the one or more panoramic cameras are also configured for image capture. The system can comprise 1, 2, 3, 4, 5, 6, 7, 8, 9, 10, or more panoramic cameras. In some cases, the housing is near rectangular shape, and the system comprises four panoramic cameras positioned at the four corners of the housing, respectively. Such positioning can provide an all-direction coverage around the housing. Alternatively, or additionally, the external device can comprise two panoramic cameras positioned at the left side and right side of the external device, respectively. In some embodiments, the system is implemented to work under surveillance mode, in which the one or more image capturing cameras conduct video surveillance, in some cases, together with the panoramic cameras. In some embodiments, the panoramic cameras are configured to conduct video surveillance at all time the system is working or under any working mode the system is set to. In some embodiments, the system is configured to record video stream obtained by the panoramic cameras and, in some cases, the image capturing cameras as well. In some embodiments, the video stream obtained by the panoramic cameras is not recorded.

In some cases, the system further comprises illumination lights, such as LED lights, that can provide illumination for image capture. Under some situations, a police vehicle can be on duty under poor lighting conditions, and the quality of the images capturing traffic violation can be affected, therefore the credibility of those images can be questioned. In order to obtain high quality images, illumination lights as provide herein can provide additional illumination for image capture under poor lighting conditions. The illumination lights can be positioned around the image capturing cameras. In certain conditions, in a system where police lights are integrated together with the image capturing cameras, illumination lights can provide further benefits. For example, the police lights can be very bright, and the proximity of police lights to the image capturing cameras can be problematic as the bright police lights can interfere the image capture by the image capturing cameras. In these examples, the illumination lights can provide backlight compensation that overcome the interference from the police lights. In some cases, the external device further comprises a light sensor. The light sensor can be configured to detect ambient lighting condition. Through the light sensor, the external device can adjust the illumination lights to provide appropriate lighting for image capture.

A speed detector as provided herein can be a radar. In some cases, a speed detector is a multi-object radar configured to track multiple objects simultaneously. In some embodiments, the speed detector is placed between two image capturing cameras. In some embodiments, the speed detector works together with the two image capturing cameras on its two sides under speed detection mode, in which the two image capturing cameras are configured to capture images of speeding vehicles detected by the speed detector. In some embodiments, the speed detector sends out a signal when speed vehicle is detected. The signal can be displayed on the terminal, or the signal can be transmitted to the image capturing cameras to trigger the image capture. In some embodiments, the speed detector is connected with a computer of the system and is configured to transmit its monitoring data to the computer, and the detection of the speeding vehicle or other types of traffic violation is performed by the computer.

A terminal as provided herein can provide a graphical user interface. The graphical user interface can be used by an operator of the system, for example, to control the image capturing cameras, speed detector, panoramic cameras, police light, illumination lights, speaker, or any other component of the system, or any combinations thereof. An operator of the system can input commend to perform any appropriate desirable adjustment of system. The terminal can also be configured to display the monitoring data obtained by the system. For instance, in some embodiments, the terminal can display the video surveillance stream obtained by the panoramic cameras and/or image capturing cameras, or snapshot images captured by the image capturing cameras. The terminal can also display processed monitoring data, such as processed images or videos, speed of detected vehicle surrounding the system, and signal of detected traffic violations. Signal of detected traffic violations can comprise alarming signal indicating the detection of a traffic violation, the type of the traffic violation, the position of the suspect vehicle, and/or the license plate number of the suspect vehicle. The terminal as provided herein can be a touch-screen monitor, which integrates both display and input system on one monitor. A touch-screen terminal can be efficient and convenient for an operator who can be driving while operating the system.

In some embodiments, the terminal can be configured to facilitate case initiation and/or management. For example, the terminal can be configured to generate a ticket when a violation is detected. In this example, the image capturing camera(s) can be configured to provide the violation information (e.g., images of violations, time of violation, location of violation, plate number, etc.) to the terminal, which in turn, is configured to generate a ticket based on the received information. The terminal can also be configured to receive input from the operator. For example, the operator can confirm the accuracy of the generated ticket (e.g., by signing the ticket).

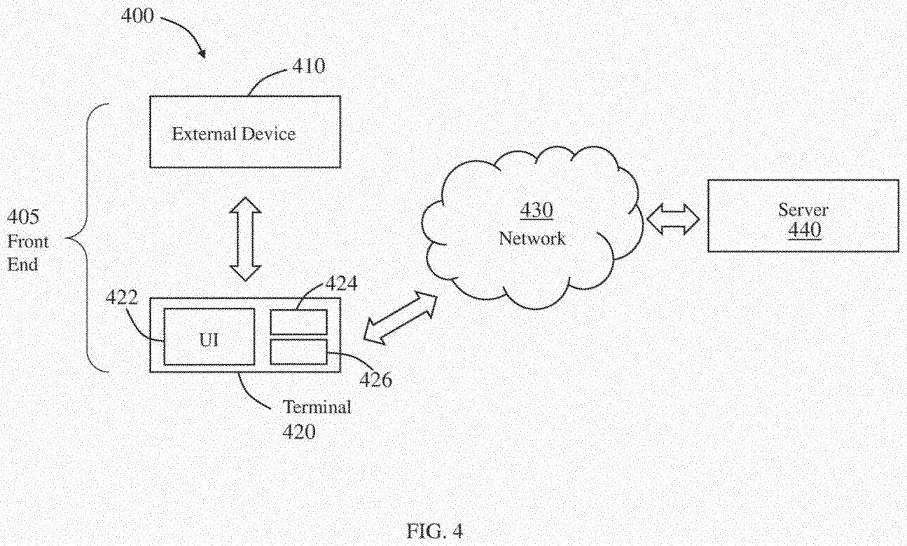

A system as provided herein can also comprise a wireless communication module. The wireless communication module can be configured to communicate with a remote server. For example, the system can transmit monitoring data to the remote server for recordation, display, or further processing. The remote server can be in a traffic monitoring center or be part of a data storage center. Alternatively or additionally, the remote server can be in another police vehicle or other traffic monitoring vehicle, for instance, for the communication between two monitoring systems. The wireless communication module can be configured to communicate with the remote server through 3G/4G/5G wireless network, WiFi, Bluetooth, or satellite-mediated transmission. More details about wireless communications of the system are provided below with reference to FIG. 4.

As system as provided herein can also comprise other components that can add on additional functions to the system. For example, the system can comprise a speaker, which can be used for sending vocal warning to suspect vehicles or making announcement on the road condition. The system can comprise a PTZ (pan-tit-zoom) camera, which can be adjusted to shoot any desired direction and used for wide range surveillance. In other examples, the system also comprises a display panel, such as a LED display panel that can be used for displaying visual warnings or making announcement on road conditions as well.

A system as provided herein can also comprise a computer. The computer can be positioned within the housing or outside the housing (e.g., within the terminal or as a standalone device). In some embodiments, the computer is configured to process and analyze image captured by the one or more image capturing cameras or speed detection data obtained by the speed detector. For example, the computer can process the captured images and send the processed images to the terminal for display. The computer can also analyze the obtained images and/or speed detection data and provide analysis results (such as speed of detected vehicles, or detected traffic violations) for display by terminal, or recordation in the system. The computer can control the one or more image capturing cameras based on analysis of the image or an input received by the terminal. The computer can also control other parts of the system based on the analysis, in some examples. For example, the computer can coordinate the image capture and the speed detection performed by the image capturing cameras and the speed detector once the analysis reports detection of a speeding vehicle. In some embodiments, the computer controls the terminal to display monitoring data obtained by the one or more image capturing cameras or the speed detector. The computer can also data storage function, so that monitoring data can be stored in the system. In some embodiments, the stored monitoring data can be retrieved for display, transmission, or further processing. The computer can be configured to analyze facial image captured by the one or more image capturing cameras. The computer can be further configured to identify a person from the facial image captured by the one or more image capturing cameras. The computer can be configured to search the facial image in a database in order to identify the person.

FIG. 1 shows a schematic of an exemplary external device 100 as provided herein. The exemplary external device 100 includes a first layer 110 and a second layer 120 operatively coupled to the first layer 110. In some implementations, the first layer 110 is disposed above the second layer 120 during use. The first layer 110 includes blue police lights 112a and red police lights 112b. In some implementations, the blue police lights 112a are disposed on a first side of the first layer 110 and the red police lights 112b are disposed on a second side, opposite the first side, of the first layer 110. In some implementations, the blue police lights 112a and the red police lights 112b can be intertwined with each other. For example, the blue police lights 112a can further include two or more panels (two panels are illustrated in FIG. 1), the red police lights 112b can also further include two or more panels, and these multiple panels can be disposed in an alternating configuration. Red color and blue color are used here for illustrative purposes. In practice, the police lights 112a and 112b can have any other appropriate colors.

The second layer 120 includes three segments and the front side of the external device 100 is shown in FIG. 1. The second layer 120 includes a speed detector 121, a first image capturing camera 122a, a first illumination device 124a (e.g., light emitting diodes or LEDs), a second image capturing camera 122b, and a second illumination device 124b that are disposed in the middle segment. In each of the side segments, namely, the left or the right segment, the second layer 120 includes one speaker 124a/124b at the front side. In addition, the second layer 120 also includes three panoramic cameras 125. Two of the panoramic cameras 125 are disposed at the corners of the external device 100 and a third panoramic camera is disposed on the side of the external device 100. An illumination device 126 is dispose beside the panoramic cameras 125 to facilitate imaging acquisition for the panoramic cameras 125 (e.g., during low light conditions). The components in the first layer 110 and the second layer 120 are substantially enclosed within a housing 130, which is configured to be coupled to a vehicle during use.

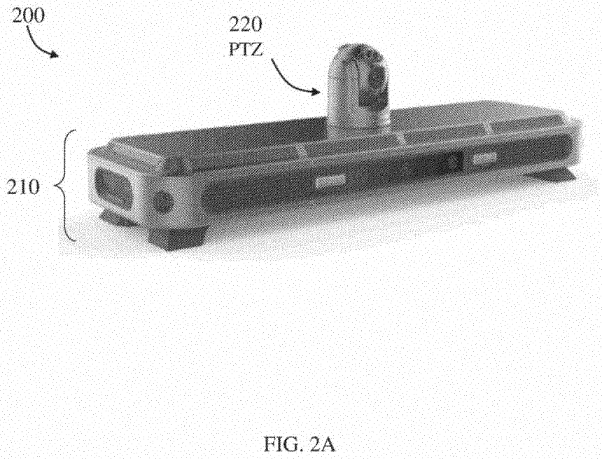

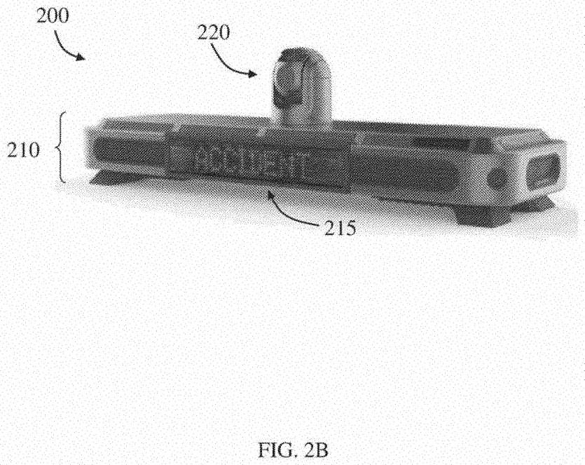

FIGS. 2A and 2B show a front view and a rear view, respectively, of another exemplary external device 200 as provided herein. The external device 200 includes a base section 210 that can be substantially similar to the external device 100 shown in FIG. 1. The external device 200 also includes a PTZ (pan-tit-zoom) camera 220 disposed on the top of the base section 210. As shown in FIG. 2B, the external device 200 also includes a display panel 215 on the back side. In some embodiments, the display panel 215 includes an LED panel, which can be configured to display, for example, warning signs. The display panel 215 can be configured to show either static or running textual or graphic signs.

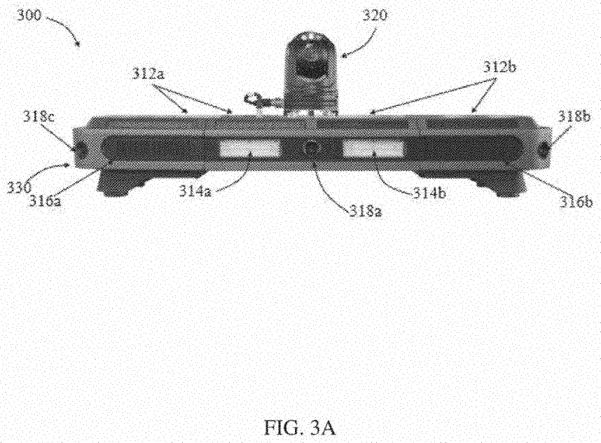

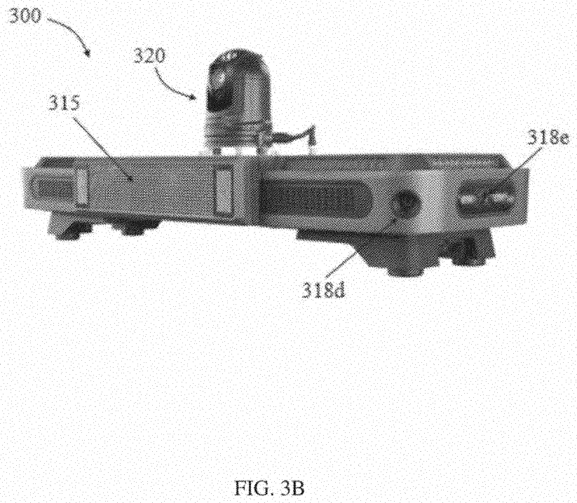

FIGS. 3A and 3B shows a front view and a rear view, respectively, of another exemplary external device 300. The external device 300 includes a first set of police lights 312a and a second set of police lights 312b. The police lights 312a and 312b can be substantially similar to the police lights 112a and 112b. The external device 300 also includes a plurality of cameras 318a, 318b, 318c, 318d, and 318e disposed around the housing 330. For example, one camera 318a can be disposed in the middle of the front side of the housing 330, the cameras 318b to 318d can be disposed at the corners of the housing 330, and the camera 318e can be disposed on a side panel of the housing 330 (as illustrated in FIG. 3B). Any other arrangement of the cameras 318a to 318e can also be used. In addition, any other number of cameras can also be used.

In some embodiments, the cameras 318a to 318e are panoramic cameras, such as cameras having a wide angle lens or a fisheye lens. In some embodiments, the cameras 318a to 318e can have different operation parameters. For example, the cameras 318a to 318d can have different focal lengths (and/or aperture sizes) so as to capture images of objects at different ranges. In another example, some of the cameras from 318a to 318e are panoramic cameras while others are cameras having a smaller field of view.

Two illumination devices 314a and 314b are disposed on the two sides of the camera 318a to facilitate the image acquisition of the camera 318a (and/or the cameras 318b to 318d). In some embodiments, the illumination devices 314a and 314b include LED lights. In some embodiments, the illumination devices 314a and 314b include flash lights. In some implementations, the illumination devices 314a and 314b can be configured for purposes other than image acquisition. For example, the illumination devices 314a and 314b can be configured to operate in a continuous mode for illumination purposes. In some embodiments, more illumination devices can be used (e.g., for each camera from 318a to 318e).

The external device 300 also includes two speakers 316a and 316b disposed on the front panel of the housing 330. The speakers 316a and 316b can be controlled by a terminal described herein (see also, e.g., FIG. 4). A PTZ camera 320 is disposed on the top panel of the housing 330. In some embodiments, the PTZ camera 320 can be configured as a surveillance video camera. In some embodiments, the PTZ camera 320 can be configured as an image capture camera. For example, when a violation is detected by other camera(s) (e.g., 318a to 318e), the PTZ camera 320 can be directed towards the direction of the violation and acquire one or more images of the violation.

FIG. 4 is a schematic of a system 400 for traffic monitoring and evidence collection. The system 400 includes an external device 410 operatively coupled to a terminal 420. The external device 410 and the terminal 420 form a front end 405. The external device 410 can be substantially similar to any of the external devices (e.g., 100-300 shown in FIGS. 1-3B) described herein and the terminal 420 can also be substantially similar to any of the terminals described herein. In some embodiments, the terminal 420 can be configured to communicate with the external device 410 via a wireless network. In some embodiments, the terminal 420 can be configured to communicate with the external device 410 via a wired network. In some embodiments, a hybrid network including both wired network and wireless network can also be used.

The system 400 also includes a server 440 in communication with the front end 405 via a wireless network 430. In some embodiments, the front end 405 is configured to communicate with the server 440 via the terminal 420 (e.g., the terminal 420 includes a communication interface). In some embodiments, the front end 405 is configured to communication with the server 440 via the external device 410 (e.g., the external device includes a communication interface). The network 430 can include any appropriate type of wireless network, such as 3G/4G/5G, LET, Bluetooth, and WiFi, among others.

In some embodiments, the terminal 420 includes a user interface 422, a memory 424, and a processor 426. The user interface 422 can be, for example, an interactive user interface (e.g., a touchscreen) that allows an operator to have bi-directional interaction with the rest of the system 400. In some embodiments, the terminal 420 can be configured as a handheld device such that an operator can carry the terminal 420 out of the vehicle during operation.

The memory 424 can include, for example, a random access memory (RAM), a memory buffer, a hard drive, a read-only memory (ROM), an erasable programmable read-only memory (EPROM), and/or the like. In some embodiments, the memory 424 is configured to store processor executable instructions for the processor 426 to implement one or more methods described herein. In some embodiments, the memory 424 is configured to store data generated by the external device 410. In some embodiments, the memory 424 is configured to store data received from the server 440. In some embodiments, the memory 424 can be configured to store one or more databases as described below. The processor 426 can be substantially similar to any of the processing units or computers described herein.

In some embodiments, the front end 405 is configured to transmit acquired data to the server 440. The acquired data includes, for example, images (or video frames) of a target vehicle, plate number of the target vehicle, and violation information associated with the target vehicle (e.g., speed of the target vehicle, location of the violation, etc.), among others. In some embodiments, the front end 405 is configured to transmit raw data to the server 440, such as the raw images and the reading from the speed detector. In some embodiments, the front end 405 is configured to perform pre-processing of the raw data to generate pre-processed data and then transmit the pre-processed data to the server 440. For example, the processor 426 in the terminal 420 can be configured to extract the plate number from a target vehicle associated with a violation (e.g., using pattern recognition) and then transmit the plate number as text (instead of images) to the server 440. Such pre-processing can be used to, for example, reduce the bandwidth used for the transmission to the server 440.

In some embodiments, the front end 405 is configured to encrypt the data transmitted to the server 440. For example, the front end 405 can be configured to add one or more password for the transmitted data. In another example, the front end 405 can be configured to add a watermark to images transmitted to the server 440. Any other encryption techniques can also be used. Such encryption can be used to prove the authenticity of the data and facilitate subsequent law enforcement, such as prosecution.

The communication between the front end 405 and the server 440 can be configured for various applications. In some embodiments, the front end 405 can retrieve more information associated with a violation. For example, the front end 405 can extract the plate number of a vehicle associated with a violation and then search the extracted plate number in a database stored on the server 440. The database can include more registration information associated with the plate number, such as the name/address of the registered owner, expiration time of the registration, build and model of the vehicle, etc. This information can be used to, for example, generate a ticket by the terminal 420.

In another example, the database stored on the server 440 can include a blacklist of plate numbers that are involved in one or more crimes (e.g., vehicles that were reported to be stolen, vehicles that were used to perpetrate crimes, such as robbery). In this example, the sever 440 can be configured to send an alarm to the terminal 420, and in response to the alarm the operator of the system 400 can take further actions, such as following the target vehicle or take control of the target vehicle. The server 440 can also be configured to send the alarm to other relevant agencies, such as police departments.

In yet another example, the server 440 may determine that the plate number received from the front end 405 is not found in the database. In this example, the server 440 can be configured to send an alarm back to the front end 405 and the operator of the system 400 can take further actions. For instance, the operator of the system 400 may determine that the plate carried by the target vehicle is not authentic and therefore can stop the target vehicle.

In some embodiments, the database (or part of the database) described herein can be stored in the memory 424 of the terminal 420. In these embodiments, the terminal 420 can retrieve the desired information without connection to the server 440.

In some embodiments, the system 400 is configured to generate a complete record of evidence for law enforcement. For example, the front end 405, upon detection of a violation, can be configured to extract the plate number of the target vehicle and acquire specific information of the violation (e.g., speed of the vehicle, location of the violation, time of the violation, etc.). The front end 405 then transmits this acquired information to the server 440, which can be configured to store the receive information and send back to the front end 405 further information associated with the violation. The further information can include, for example, registration information of the target vehicle, violation history of the target vehicle, and potential penalties applied to the violation, among others. The front end 405, upon receiving this further information, can be configured to generate a ticket associated with the violation and send the ticket back to the server 440 for record. These operations can generate a complete and reliable record of evidence for subsequent enforcement (e.g., prosecution).

In addition to traffic monitoring, apparatus, systems, and methods described herein can also be configured for enforcing criminal law, including crime investigations. Without loss of generality, the following description of criminal law enforcement uses the system 400 as an example. When used for the purpose of enforcing criminal law, the operation mode of the system 400 is referred to as the criminal enforcement mode.

In some embodiments, the front end 405 is coupled to a vehicle (e.g., a police car) and configured to continuously acquire images (including videos streams) of the surrounding environment. At the same time, the processor 426 in the terminal 420 can be configured to extract plate numbers of every vehicle in the acquired images and then send the extracted plate numbers to the server 440 for potential matching. The server 440 can be configured to search the received plate numbers in one or more databases that include information about suspect vehicles (e.g., vehicles that are involved or believed to be involved in crimes). If the server 440 finds a match, the server 440 is configured to send a signal back to the front end 405 such that the operator of the front end 405 can take further actions, such as following the suspect vehicle or acquire more information about the suspect vehicle.

In some embodiments, the front end 405 can be configured to acquire facial images (including video streams) of pedestrians or drivers in vehicles. In one example, the front end 405 can perform facial recognition and then send the facial recognition data to the server 440 for potential matching. The server 440 can include one or more databases that are stored with facial information about suspects of crimes. Once a match is found, the server 440 is configured to send a signal to the front end 405 such that the operator of the front end 405 can take further actions. In another example, the front end 405 can send the facial images to the server 440, which is configured to perform the facial recognition. In yet another example, the front end 405 can be configured to perform some pre-processing, such as filtering and feature extraction, and then send the pre-processed data to the server 440 for potential matching.

Although only one server 440 is illustrated in FIG. 4, more than one server can be included in the system 400. For example, the server 440 can include multiple devices that are distributed in various locations but are connected via networks. In this example, the frond end 405 is configured to communicate with each device as if the multiple devices form a single logical entity. The multiple devices can include multiple servers located in different agencies or in different jurisdictions. These different agencies or jurisdictions can share their databases so as to increase the efficiency of law enforcement.

The criminal enforcement mode has several benefits. First, the criminal enforcement mode takes advantage of the mobility of existing police cars to collect data. For example, most police cars have routine patrols, during which the front end 405 can be used to collect data for criminal investigation. Second, the mobility of the police cars can also effectively cover blind zones of fixed surveillance cameras and therefore acquire data that is not collectable by fixed surveillance cameras. Third, the criminal enforcement mode allows prompt actions of law enforcement personnel once a suspect or a threat is detected because the server 440 is in real-time communication with the police cars carrying the front end 405.

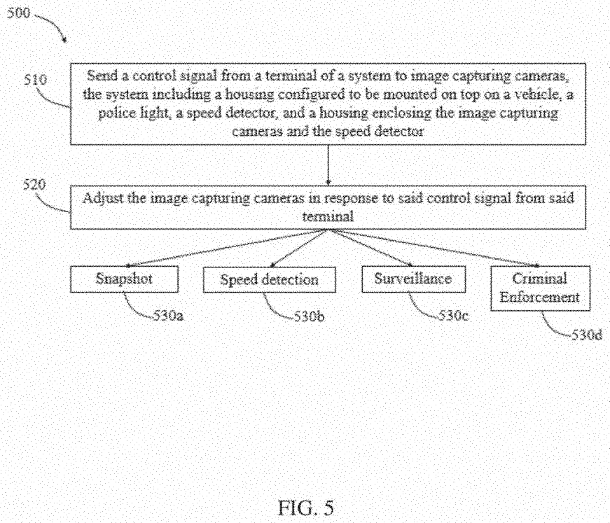

FIG. 5 is a flowchart illustrating a method of traffic monitoring and evidence collection. Using devices and systems described herein, an operator can adjust the one or more image capturing cameras to capture images of traffic violations. Another aspect of the present disclosure provides a method 500 of adjusting a camera. The method 500 can comprise, at 510, sending a control signal from a terminal of a system as provided herein. The method 500 also includes, at 520, adjusting the one or more image capturing cameras in response to the control signal from the terminal. A method of adjusting a camera as provided herein can be a method of traffic monitoring and evidence collection.

A control signal as described herein can be a signal that sets the system in one of the following working modes 530a to 530d. During the snapshot mode 530a, the one or more image capturing cameras in the system are configured to capture snapshot images. For example, the system may determine that a violation is detected and then controls the cameras to take snapshot images associated with the violation. During the speed detection mode 530b, the one or more image capturing cameras are configured to capture images of a speeding vehicle detected by the speed detector. For example, a processor in the system can receive speed information from the speed detector and determine that a target vehicle has exceeded the legal speed limit. In this case, the processor can control the cameras to take one or more images of the target vehicle. During the surveillance mode 530c, the one or more image capturing cameras are configured to capture video stream. During the criminal enforcement mode 530d, the one or more image capturing cameras are configured to take images of surrounding vehicles, pedestrians, and/or people within vehicles. The system then extracts the plate numbers of vehicles for crime inspection. The system can also perform facial recognition to identify potential suspect or threat to public safety.

In some embodiments, the system can set the one or more image capturing cameras in multiple working modes simultaneously. As such, an operator of the system can send a control signal from the terminal of the system to set the system in one of the working modes. The control signal can also be a signal to adjust one or more configurations of the one or more image capturing cameras, such as, but not limited to, focal plane, orientation, positioning relative to the housing, exposure time, and frame rate.

The method 500 as described herein can also comprise sending a monitoring commend from the terminal of the system to control the speed detector to detect the object; control the police light; control illumination lights of the system to provide illumination for the image capturing; control alarm speaker of the system; control one or more panoramic cameras of the system to conduct surveillance; or control a satellite-based radionavigation receiver of the system to obtain positioning information of the system.

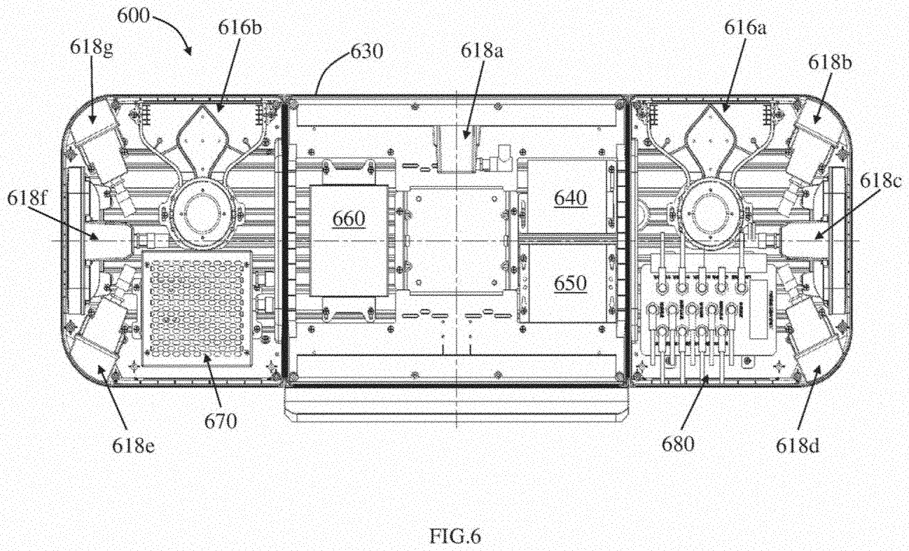

FIG. 6 is a cross sectional view of an exemplary external device 600. The external device 600 includes a housing 630 enclosing seven cameras 618a, 618b, 618c, 618d, 618e, 618f, and 618g (collectively referred to as cameras 618). A first camera 618a is disposed in the middle of the front side of the housing. Two cameras 618c and 618f are disposed on the two side panels of the housing 630. In addition, four cameras 618b, 618d, 618e, and 618g are disposed on the four corners of the housing 630. In some embodiments, at least some of the cameras 618 include panoramic cameras. The external device 600 also includes network video recorder (NVR) 670, which is configured to receive images (including videos streams) acquired by the cameras 618. In some embodiments, the NVR 670 can also be configured to store and manage the received images. In some embodiments, the NVR 670 is operatively coupled to a terminal (e.g., similar to terminal 420, not shown in FIG. 6) such that an operator of the terminal can manage the images acquired by the cameras 618. For example, an operator can replay the images, edit the images, or send selected images for further processing.

A network switch 640 is included in the external device 600 to facilitate the communications between the cameras 618 and the NVR 670. The network switch 640 can also be configured to facilitate communication between the external device 600 and other devices (e.g., a terminal, a remote server, or other external devices mounted on different vehicles, among others). Two speakers 616a and 616b are disposed on the front side of the housing 630. The external device includes a siren 660 (also referred to as an alarm 660) operatively coupled to the two speakers 616a and 616b, which can be configured to play alarm ringtones provided by the siren 660.

The external device 600 further includes a smart processing unit 650 that is configured to perform pattern recognition, including extraction of plate numbers, facial recognition, and any other processing described herein. A controller 680 is operatively coupled to all the electrical components in the housing (e.g., cameras 618, speakers 616, network switch 640, smart processing unit 650, and NVR 670) and configured for power and data management.

In some embodiments, the external 600 can further include an optional speed detector (not shown in FIG. 6). The speed detector 600 can be operatively coupled to the network switch 640, the smart processing unit 650, and the controller 680. In some implementations, the smart processing unit 650 can be configured to process data acquired by the speed detector. For example, the smart processing unit 650 can be configured to determine the relative and/or absolute speed of a target vehicle and also determine whether the target vehicle commits any traffic violation. In some implementations, the network switch 640 can be configured to route the data acquired by the speed detector to other devices (e.g., the terminal).

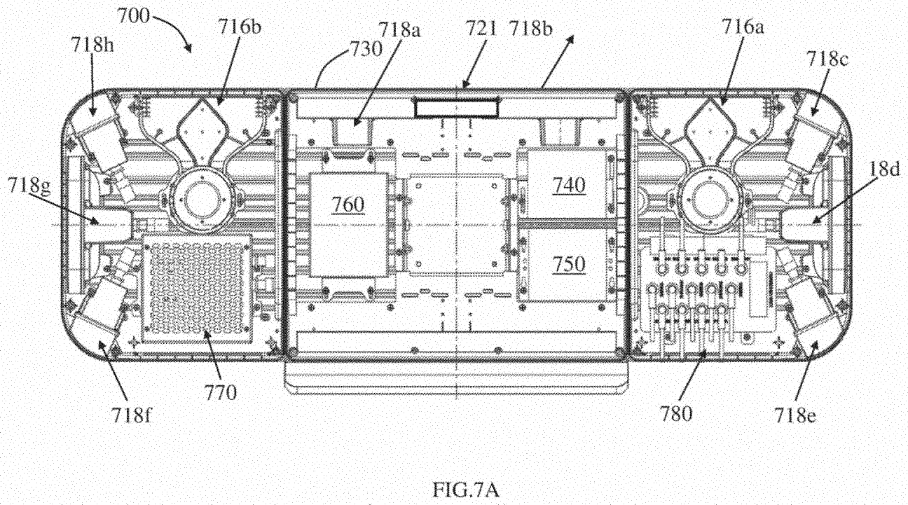

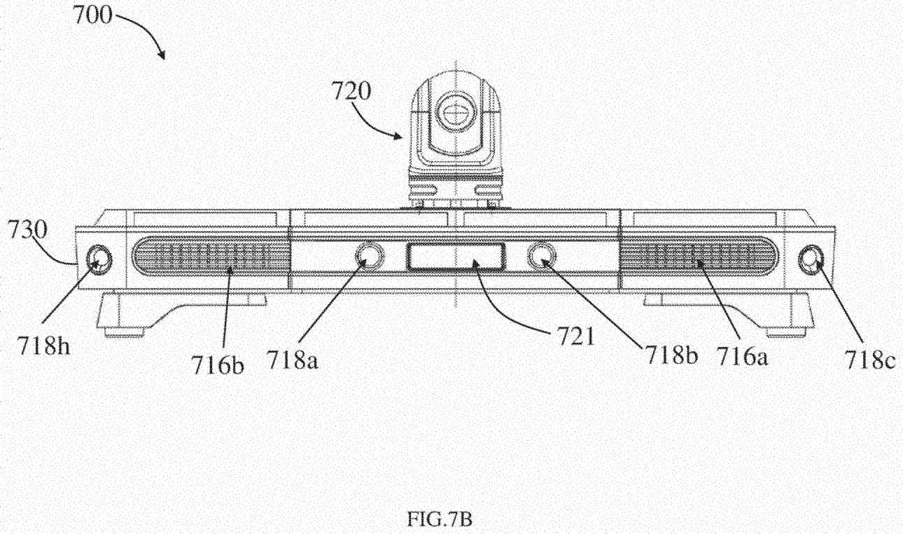

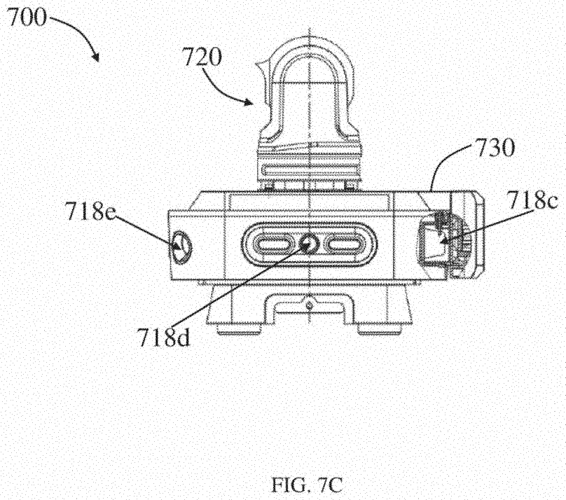

FIGS. 7A-7C show a cross sectional view, a front view, and a side view, respectively, of another exemplary external device 700. The external device 700 includes a housing 730 that is configured to enclose most elements in the external device 700. For example, multiple cameras 718a to 718h are disposed around the housing 730. Two cameras 718a and 718b are disposed on the front side of the housing 730. Four cameras 718c, 718e, 718f, and 718h are disposed on the four corners of the housing 730. Two more cameras 718d and 718g are disposed on the two side panels of the housing 830. In some embodiments, the two cameras 718a and 718b can be configured to increase the field of view of each individual camera.

The external device 700 also includes a speed detector 721 disposed between the two cameras 718a and 718b. Two speakers 716a and 716b are disposed beside the two cameras 718a and 718b. In the middle section of the housing 730, a network switch 740 is included in the external device 700 for network communication with other devices, a smart processing unit 750 is included to process data acquired by the cameras 718a to 718h, and a siren 760 is included to provide alarm signals (e.g., played via the speakers 716a and 716b).

The left side of the housing 730 is configured to hold an NVR 760 that is configured to store and manage images (including video streams) acquired by the cameras 718a to 718h. The right side of the housing 730 is configured to hold a controller 780 that is configured to manage the power and data of the external device 700.

The external device 700 also includes a PTZ camera 720 disposed on the top cover of the housing 730. In some embodiments, the PTZ camera 720 is configured to operate in a surveillance mode, i.e., continuously acquiring images of the surrounding environment, and the smart processing unit 750 is configured to process images acquired by the PTZ camera 720 to detect potential violation or threat to public safety (e.g., via pattern recognition). Once a violation or threat is detected, the smart processing unit 750 is configured to identify which camera(s) from the cameras 718a to 718h has the best field of view to take images associated with the violation or threat and then send a signal to the identified camera for image acquisition.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above. While specific methods of facial recognition have been described above according to specific embodiments, in some instances, any of the methods of facial recognition can be combined, augmented, enhanced, and/or otherwise collectively performed on a set of facial recognition data. For example, in some instances, a method of facial recognition can include analyzing facial recognition data using Eigenvectors, Eigenfaces, and/or other 2-D analysis, as well as any suitable 3-D analysis such as, for example, 3-D reconstruction of multiple 2-D images. In some instances, the use of a 2-D analysis method and a 3-D analysis method can, for example, yield more accurate results with less load on resources (e.g., processing devices) than would otherwise result from only a 3-D analysis or only a 2-D analysis. In some instances, facial recognition can be performed via convolutional neural networks (CNN) and/or via CNN in combination with any suitable two-dimensional (2-D) and/or three-dimensional (3-D) facial recognition analysis methods. Moreover, the use of multiple analysis methods can be used, for example, for redundancy, error checking, load balancing, and/or the like. In some instances, the use of multiple analysis methods can allow a system to selectively analyze a facial recognition data set based at least in part on specific data included therein.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware sections may include, for example, a general-purpose processor, a field programmable gate array (FPGA), and/or an application specific integrated circuit (ASIC). Software sections (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

We claim:

1. A system, comprising:
a housing configured to be mounted on top of a vehicle;
a police light;
a terminal located outside said housing and configured to send a control signal; and
one or more image capturing cameras configured to capture image in response to said control signal from said terminal, wherein said one or more image capturing cameras are located within said housing.

2. The system of claim 1, further comprising a speed detector.

3. The system of claim 2, wherein said speed detector is a multi-target tracking radar configured to track and detect speed of multiple objects.

4. The system of any one of claims 1 to 3, comprising two image capturing cameras positioned on a front side of said housing.

5. The system of claim 4, wherein optical axes of said two image capturing cameras intersect at back of said two front-facing cameras.

6. The system of claim 4, wherein optical axes of said two image capturing cameras are parallel to each other.

7. The system of claim 4, wherein said two image capturing cameras are configured to have a combined field of view that is at least 120 degree, at least 150 degree, or 180 degree.

8. The system of any one of claims 4 to 7, wherein said speed detector is positioned between said two image capturing cameras.

9. The system of any one of claims 1 to 8, wherein said one or more image capturing cameras are affixed to said housing.

10. The system of any one of claims 1 to 9, wherein said one or more image capturing cameras have an image resolution that is at least 1 megapixel, at least 5 megapixel, at least 10 megapixel, at least 50 megapixel, or at least 100 megapixel.

11. The system of any one of claims 1 to 10, wherein said one or more image capturing cameras have a frame rate of at least about 100 fps (frames per second), at least about 250 fps, at least about 500 fps, or at least about 1000 fps.

12. The system of any one of claims 1 to 11, wherein said one or more image capturing cameras are configured to capture moving images with exposures of less than about 2 ms, less than about 1 ms, less than about 0.8 ms, less than about 0.6 ms, less than about 0.5 ms, less than about 0.4 ms, less than about 0.2 ms, or less than about 0.1 ms.

13. The system of any one of claims 1 to 12, further comprising a processing unit configured to detect a traffic violation based on analysis of surveillance image obtained by said at least one of said image capturing cameras.

14. The system of claim 13, wherein said processing unit is configured to trigger said image capturing camera to capture an image of said detected traffic violation.

15. The system of claim 13 or 14, wherein said processing unit is configured to detect a traffic violation selected from the group consisting of: driving in a reverse direction, failing to drive within a single lane, crossing over a center divider, median or gore, driving in an unauthorized lane, driving on a shoulder, parking violation, and any combinations thereof.

16. The system of any one of claims 1 to 15, further comprising one or more panoramic cameras.

17. The system of claim 16, comprising four panoramic cameras positioned at four corners of said housing.

18. The system of claim 16 or 17, comprising two panoramic cameras positioned at a left side and a right side of said housing, respectively.

19. The system of any one of claims 1 to 18, further comprising a plurality of illumination lights configured to provide illumination for image capture, wherein said illumination lights are attached to said housing.

20. The system of any one of claims 1 to 19, further comprising a light sensor, and wherein said system is configured to detect ambient lighting condition through said light sensor and adjust said illumination from said illumination lights based on said detected ambient lighting condition.

21. The system of any one of claims 1 to 20, further comprising a satellite-based radionavigation receiver configured to obtaining positioning information of said system.

22. The system of claim 21, wherein said system is configured to obtain and record positioning information of a traffic violation.

23. The system of any one of claims 1 to 22, wherein said police light is positioned above said one or more image capturing cameras.

24. The system of any one of claims 1 to 23, further comprising a speaker attached to said housing.

25. The system of claim 24, wherein said speaker is placed within said housing.

26. The system of any one of claims 1 to 25, further comprising LED display panel attached to said housing.

27. The system of claim 26, wherein said LED display is at back side of said housing.

28. The system of any one of claims 1 to 27, further comprising a wireless communication module configured to communicate with a remote server.

29. The system of claim 28, wherein said wireless communication module communicates with said remote server through 3G/4G wireless network, WiFi, or Bluebooth.

30. The system of any one of claims 1 to 29, wherein said terminal is configured to provide a graphical user interface for an operator of said system.

31. The system of claim 30, wherein said terminal comprises a touch-screen monitor configured to receive input from said operator.

32. The system of any one of claims 1 to 31, further comprising a computer configured to:
(1) process and analyze image captured by said one or more image capturing cameras or speed detection data obtained by said speed detector;
(2) control said one or more image capturing cameras based on analysis of said image or an input received by said terminal; or
(3) control said terminal to display monitoring data obtained by said one or more image capturing cameras or said speed detector.

33. The system of claim 32, wherein said computer is positioned within said housing.

34. The system of claim 32, wherein said computer is positioned outside said housing.

35. The system of any one of claims 32 to 34, wherein said computer is configured to analyze facial image captured by said one or more image capturing cameras.

36. The system of claim 35, wherein said computer is further configured to identify a person from said facial image captured by said one or more image capturing cameras.

37. A method of adjusting a camera, comprising:
a) sending a control signal from a terminal of a system to one or more image capturing cameras, wherein said system comprises:
a housing configured to be mounted on top on a vehicle;
a police light;
said terminal located outside said housing; and
said one or more image capturing cameras, wherein said one or more image capturing cameras are located within said housing; and
b) adjusting said one or more image capturing cameras in response to said control signal from said terminal.

38. The method of claim 37, wherein said adjusting comprises setting said one or more image capturing cameras in one or more of the following modes:
(i) snapshot mode, in which said one or more image capturing cameras are configured to capture snapshot images;
(ii) speed detection mode, in which said one or more image capturing cameras are configured to capture images of a speeding vehicle detected by a speed detector; and
(iii) surveillance mode, in which said one or more image capturing cameras are configured to capture video stream.

39. The method of claim 37 or 38, wherein said adjusting comprises adjusting one or more configurations of said one or more image capturing cameras selected from the group consisting of: focal plane, orientation, positioning relative to said housing, exposure time, and frame rate.

40. The method of any one of claims 37 to 39, further comprising: sending a monitoring commend from said terminal to:
control the speed detector to detect said object; control said police light; control illumination lights of said system to provide illumination for said image capturing; control alarm speaker of said system; control one or more panoramic cameras of said system to conduct surveillance; or control a satellite-based radionavigation receiver of said system to obtain positioning information of said system.

41. The method of any one of claims 37 to 40, wherein said system further comprises a speed detector.

42. The method of claim 41, wherein said speed detector is a multi-target tracking radar configured to track and detect speed of multiple objects.

43. The method of any one of claims 37 to 42, wherein said system comprises two image capturing cameras positioned on a front side of said housing.

44. The method of claim 43, wherein optical axes of said two image capturing cameras intersect at back of said two front-facing cameras.

45. The method of claim 43, wherein optical axes of said two image capturing cameras are parallel to each other.

46. The method of any one of claims 43 to 45, wherein said two image capturing cameras are configured to have a combined field of view that is at least 120 degree, at least 150 degree, or 180 degree.

47. The method of any one of claims 43 to 46, wherein the speed detector is positioned between said two image capturing cameras.

48. The method of any one of claims 37 to 47, wherein said one or more image capturing cameras are affixed to said housing.

49. The method of any one of claims 37 to 48, wherein said one or more image capturing cameras have an image resolution that is at least 1 megapixel, at least 5 megapixel, at least 10 megapixel, at least 50 megapixel, or at least 100 megapixel.

50. The method of any one of claims 37 to 49, wherein said one or more image capturing cameras have a frame rate of at least about 100 fps (frames per second), at least about 250 fps, at least about 500 fps, or at least about 1000 fps.

51. The method of any one of claims 37 to 50, wherein said one or more image capturing cameras are configured to capture moving images with exposures of less than about 2 ms, less than about 1 ms, less than about 0.8 ms, less than about 0.6 ms, less than about 0.5 ms, less than about 0.4 ms, less than about 0.2 ms, or less than about 0.1 ms.

52. The method of any one of claims 37 to 51, wherein said image capturing camera comprises a processing unit configured to detect a traffic violation based on analysis of surveillance images obtained by said at least one of said image capturing cameras.

53. The method of claim 52, wherein said processing unit is configured to trigger said image capturing camera to capture an image of said detected traffic violation.

54. The method of claim 52 or 53, wherein said processing unit is configured to detect a traffic violation selected from the group consisting of: driving in a reverse direction, failing to drive within a single lane, crossing over a center divider, median or gore, driving in an unauthorized lane, driving on a shoulder, parking violation, and any combinations thereof.

55. The method of any one of claims 37 to 54, wherein the system further comprises a multi-target tracking radar configured to track and detect speed of multiple objects.

56. The method of any one of claims 37 to 55, wherein said system further comprises one or more panoramic cameras.

57. The method of claim 56, wherein said system comprises four panoramic cameras positioned at four corners of said housing.

58. The method of claim 56 or 57, wherein said system comprises two panoramic cameras positioned at a left side and a right side of said housing, respectively.

59. The method of any one of claims 37 to 58, wherein said system further comprises a plurality of illumination lights configured to provide illumination for image capture, wherein said illumination lights are attached to said housing.

60. The method of claim 59, wherein said system further comprises a light sensor, and wherein said system is configured to detect ambient lighting condition through said light sensor and adjust said illumination from said illumination lights based on said detected ambient lighting condition.

61. The method of any one of claims 37 to 60, wherein said system further comprises a satellite-based radionavigation receiver configured to obtaining positioning information of said system.

62. The method of claim 61, wherein said system is configured to obtain and record positioning information of a traffic violation.

63. The method of any one of claims 37 to 62, wherein said police light is positioned above said one or more image capturing cameras.

64. The method of any one of claims 37 to 63, wherein said system further comprises a speaker attached to said housing.

65. The method of claim 64, wherein said speaker is placed within said housing.

66. The method of any one of claims 37 to 65, wherein said system further comprises LED display panel attached to said housing.

67. The method of claim 66, wherein said LED display is at back side of said housing.

68. The method of any one of claims 37 to 67, further comprising a wireless communication module configured to communicate with a remote server.

69. The method of claim 68, wherein said wireless communication module communicates with said remote server through 3G/4G wireless network, WiFi, or Bluebooth.

70. The method of any one of claims 37 to 69, wherein said terminal is configured to provide a graphical user interface for an operator of said system.

71. The method of claim 70, wherein said terminal comprises a touch-screen monitor configured to receive input from said operator.

72. The method of any one of claims 37 to 71, wherein said terminal further comprises a computer configured to:
(1) process and analyze image captured by said one or more image capturing cameras or speed detection data obtained by said speed detector;
(2) control said one or more image capturing cameras based on analysis of said image or an input received by said terminal; or
(3) control said terminal to display monitoring data obtained by said one or more image capturing cameras or said speed detector.

73. The method of claim 72, wherein said computer is positioned within said housing.

74. The method of claim 72, wherein said computer is positioned outside said housing.

75. The method of any one of claims 72 to 74, wherein said computer is configured to analyze facial image captured by said one or more image capturing cameras.

76. The method of claim 75, wherein said computer is further configured to identify a person from said facial image captured by said one or more image capturing cameras.
